(19) United States
(12) Patent Application Publication
(10) Pub. No.: US 2006/0045425 A1
(43) Pub. Date: Mar. 2, 2006

(54) Wavelength-selectable device and optical communication system including the same

(76) Inventors: Tomohiko Kanie, Yokohama-shi (JP); Makoto Katayama, Yokohama-shi (JP)

Correspondence Address: MCDERMOTT WILL & EMERY LLP, 600 13TH STREET, N.W., WASHINGTON, DC, 20005-3096, US

(21) Appl. No.: 11/214,017

(22) Filed: Aug. 30, 2005

Related U.S. Application Data
(60) Provisional application No. 60/606,428, filed on Sep. 2, 2004.

(30) Foreign Application Priority Data
Sep. 2, 2004 (JP) P2004-255933

(51) Int. Cl. G02B 6/26; G02B 6/42

(52) U.S. Cl. 385/47; 385/39; 385/40; 385/19; 385/18; 385/50

(57) ABSTRACT

The present invention relates to a wavelength-selectable device of a smaller structure capable of selecting a wavelength. The wavelength-selectable device has a waveguide substrate in which optical waveguides are built, a wavelength selector, and a movable mirror. The wavelength selector is fixed at a position where light propagating in the optical waveguide arrives, and the movable mirror is arranged to be movable between a first position where the light propagating in the optical waveguide arrives and a second position off the optical waveguide. This configuration achieves the wavelength-selectable device in the smaller structure.

### CROSS-REFERENCE TO RELATED APPLICATION

This application claims priority to Provisional Application Ser. No. 60/606,428 filed on Sep. 2, 2004 by the same Applicant, which is hereby incorporated by reference in its entirety.

### BACKGROUND OF THE INVENTION

1. Field of the Invention

The present invention relates to a wavelength-selectable device of a waveguide type for blocking or transmitting light in a predetermined wavelength band of an incident wavelength band, and an optical communication system to which the wavelength-selectable device is applicable.

2. Related Background Art

Recently, there has been growing multimedia communication as combination of a variety of multimedia such as sound, image, and text information. Among others, users are continuing to increase exponentially in broadband communication to provide the multiplex of the Internet with the data communication service such as e-mail, the video delivery service, and so on. Such multimedia communication is implemented by communication systems making use of metal cables or optical fiber cables, and there exist various systems; for example, the optical communication systems incorporating the optical fiber cables as transmission media include an optical communication system for transmitting digital signals and analog signals in a multiplexed state, an optical communication system for transmitting multiple types of analog signals as assigned to their respective different channels (wavelength bands), an optical communication system for transmitting multiple types of digital signals as assigned to their respective different channels, an optical communication system for transmitting a video signal, a sound signal, and a data signal in a multiplexed state, an optical communication system for transmitting an identical data signal to different subscribers while assigning the data signal to different channels, and so on.

Among the various broadband communication systems, a significant increase is shown, particularly, in the number of users of the FTTH (Fiber To The Home) service for delivering information from a terminal in an existing communication network through an optical fiber to each home. This FTTH service is excellent in terms of communication speed and communication quality and also excellent in service extensibility such as wavelength division multiplexing, and is expected as a key communication system taking a major role in widespread use and expansion of the broadband communication. Namely, the current FTTH service is directed to only transmission/reception of digital data signals, but further development to the wavelength division multiplexing service is expected on the basis of optical fiber networks now under development, because the optical fiber has a great feature of capability of simultaneous transmission of multiple wavelengths. For this reason, fingers are pointed at the probability of feasibility of a greater diversity of services, not only the delivery of the digital data signals used in the Internet or the like, but also the delivery of video signals by the analog transmission system, without significant capital expenditure.

FIGS. 8A and 8B are illustrations each showing a schematic configuration of a conventional optical communication system described in OPTRONICS (2004), No. 1, pp. 167-193 (Printed on January, 2004). As shown in this FIG. 8A, the conventional optical communication system is provided with an optical fiber network 30 connecting a communication center 10 as a transmitting station to a subscriber home 20.

The communication center 10 functions as a server for transmitting and receiving a digital data signal S1 used in the data communication service such as the Internet, to and from the subscriber home 20, and also functions as a transmitting station for delivering a subscribed analog video signal S2 to the subscriber home 20. For this purpose, the communication center 10 is equipped with a video signal transmitter 11 for outputting the analog video signal S2, an optical splitter 12 for splitting the analog video signal S2 into signals to be delivered to respective terminals (final repeaters for simultaneously delivering the signals to subscriber homes included in a delivery target group), and an optical multiplexer/demultiplexer 13 for multiplexing the digital data signal S1 and the analog video signal S2.

The optical fiber network 30 is installed between the final repeater (terminal) in an existing upper communication network, such as the Internet, and the subscriber home 20, and a closure including an optical splitter 31 as one or more branch points is set in this optical fiber network 30.

On the other hand, the subscriber home 20 for receiving the multiplexed signals (including the digital data signal S1 and the analog video signal S2) is equipped with a personal computer (PC) 22 as a terminal making use of the digital data signal S1, and a television set (TV) 23, for example, as a terminal making use of the analog video signal S2. This subscriber home 20 is provided with an optical multiplexer/demultiplexer 21 for demultiplexing the received multiplexed signals into the digital data signal S1 and the analog video signal S2.

Particularly, the optical multiplexer/demultiplexer 13 (21) is constructed using an optical system, or is constructed of a dielectric multilayer filter 131, and two couplers 130 arranged on both sides of the dielectric multilayer filter, which are connected each through an optical fiber, as shown in FIG. 8B.

### SUMMARY OF THE INVENTION

The Inventors investigated the optical multiplexer/demultiplexers applied to the conventional optical communication systems and found the following problem. Namely, the optical multiplexer/demultiplexers applied to the optical communication systems providing the conventional FTTH service had the configuration in which the plurality of optical components were connected through the optical fiber as shown in FIG. 8B, and it was thus difficult to secure an installation space. As a result, there arose the problem that the installation place of the optical multiplexer/demultiplexer was limited, in application to the conventional optical communication systems.

The present invention has been accomplished in order to solve the problem as described above, and an object of the invention is to provide a wavelength-selectable device capable of selecting a wavelength in a smaller structure, and an optical communication system incorporating the same.

A wavelength-selectable device according to the present invention is a wavelength-selectable device of a waveguide type for blocking or transmitting light in a predetermined wavelength band of an incident wavelength band. Systems to which this wavelength-selectable device is applicable include, for example, an optical communication system such as broadband communication to deliver digital data signals used in the Internet or the like and analog video signals used in the video delivery service or the like, an optical communication system for transmitting multiple types of analog signals as assigned to their respective different channels (wavelength bands), an optical communication system for transmitting a plurality of types of digital data signals as assigned to their respective different channels, an optical communication system for transmitting a video signal, a sound signal, and a data signal in a multiplexed state, an optical communication system for transmitting an identical data signal to different subscribers while assigning the data signal to different channels, and so on. In particular, attention is currently being drawn toward the optical communication systems for providing the FTTH service to deliver multiplexed digital data and analog video signals to an arbitrary subscriber home, while connecting a final repeater (terminal) in an existing upper communication network to each subscriber home through an optical fiber, and thus the wavelength-selectable device of the present invention can be expected to be applied to the optical communication systems for providing such FTTH service.

The wavelength-selectable device according to the present invention is a waveguide type device integrally constructed of a waveguide substrate with an optical waveguide built therein, a wavelength selector, and a movable reflecting surface, and has a structure enabling further downsizing. In particular, the wavelength selector is fixed at a predetermined location on the waveguide substrate, where light propagating in the optical waveguide arrives. On the other hand, the movable reflecting surface is arranged on the waveguide substrate and in a movable state between a first position where the light propagating in the optical waveguide arrives and a second position off the optical waveguide. By moving the movable reflecting surface in this manner, it becomes feasible to switch between a propagation path through which the light having entered the wavelength-selectable device can arrive at the wavelength selector and a propagation path through which the light cannot arrive at the wavelength selector.

A specific configuration applicable herein is, for example, the waveguide substrate in which the above optical waveguide comprises an input optical waveguide and an output optical waveguide arranged to intersect at a plurality of locations. In this case, the movable reflecting surface is arranged to be movable between a first intersection of the input optical waveguide and the output optical waveguide and a position off the first intersection. The wavelength selector is fixed at a second intersection of the input optical waveguide and the output optical waveguide. In this specification, the “intersection of the input optical waveguide and the output optical waveguide” refers to a portion where an optical path of light propagating in the input optical waveguide intersects with an optical path of light propagating in the output waveguide.

A dielectric multilayer filter is commonly used as the wavelength selector, but the wavelength selector may be comprised, for example, of a reflecting surface fixed at the second intersection of the input optical waveguide and the output optical waveguide, and a diffraction grating for transmitting light of a specific wavelength only, which is placed on a linear portion of either of the input optical waveguide and the output optical waveguide. The wavelength selector can also be implemented by a special waveguide structure and a diffraction grating. Namely, it is also possible to use a waveguide substrate wherein the optical waveguide comprises an input optical waveguide and an output optical waveguide arranged to intersect at an intersection and wherein there is a loop waveguide both ends of which are optically connected to the input and output waveguides, respectively, through the intersection. In this case, the diffraction grating as the wavelength selector is placed on a linear portion of the loop waveguide, thereby obtaining the wavelength selector for guiding light of a desired wavelength only to the output waveguide without need for a reflecting surface.

The wavelength-selectable device according to the present invention can also use a waveguide substrate wherein the optical waveguide comprises an input optical waveguide and an output optical waveguide arranged to intersect at least at one location. In this case, the wavelength selector is fixed at the intersection of the input optical waveguide and the output optical waveguide, and the movable reflecting surface is also arranged to be movable between the intersection of the input optical waveguide and the output optical waveguide and a position off the intersection.

However, in the configuration wherein the wavelength selector and the movable reflecting surface are arranged at one intersection as described above, the movable reflecting surface moves so as to slide in front of the wavelength selector (on the side where the light from the input optical waveguide arrives). In that case, for example, where the movable reflecting surface is a mirror, the thickness of the mirror can pose a problem. As long as the mirror is thin enough, reflected light from the mirror arrives substantially at the same position as reflected light from the wavelength selector does. However, at the case that the mirror is thick, the arrival positions of the respective reflected beams will largely deviate from each other. In such cases where a thick mirror is applied as the movable reflecting surface as described, therefore, the output optical waveguide preferably has a first input end into which the reflected light from the mirror is incident when the mirror is placed at the intersection of the input optical waveguide and the output optical waveguide, and a second input end into which the reflected light from the wavelength selector is incident when the mirror is placed at the position off the intersection of the input optical waveguide and the output optical waveguide.

The wavelength-selectable device according to the present invention may be so configured that it comprises a common waveguide substrate in which a plurality of pairs of input optical waveguides and output optical waveguides are flatly built and that the aforementioned movable reflecting surface and wavelength selector are arranged at predetermined positions for each of these pairs. In this case, it becomes feasible to implement integration of a plurality of wavelength selection mechanisms.

In any of the above-described configurations, the movable reflecting surface may be moved by hand, or by a driving mechanism such as an MEMS (Micro-Electro-Mechanical System).

In accordance with the present invention, as described above, the waveguide substrate with the input optical waveguide and the output optical waveguide therein is provided with the wavelength selector fixed in position and the movable reflecting surface arranged to be movable, which enables downsizing of the device itself and increases the degrees of freedom for its installation position in an optical communication system to which the device is applied.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIGS. 1A and 1B are illustrations each showing a schematic configuration of a wavelength-selectable device according to the present invention;

FIGS. 2A and 2B are plan views each showing a configuration of a first embodiment of the wavelength-selectable device according to the present invention;

FIGS. 3A and 3B are plan views each showing a configuration of a second embodiment of the wavelength-selectable device according to the present invention;

FIGS. 4A and 4B are plan views each showing a configuration of a third embodiment of the wavelength-selectable device according to the present invention;

FIGS. 5A and 5B are plan views each showing a configuration of a fourth embodiment of the wavelength-selectable device according to the present invention;

FIG. 6 is a plan view showing a configuration of a fifth embodiment of the wavelength-selectable device according to the present invention;

FIG. 7 is an illustration showing a schematic configuration of an optical communication system according to the present invention; and

FIGS. 8A and 8B are illustrations each showing a schematic configuration of a conventional optical communication system.

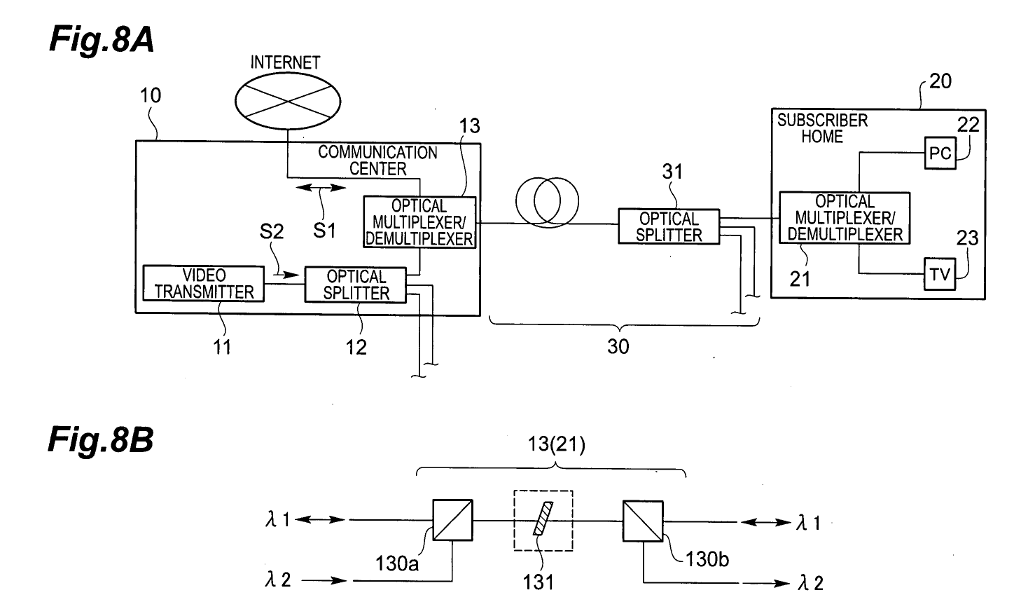

### DETAILED DESCRIPTION OF THE PREFERRED EMBODIMENTS

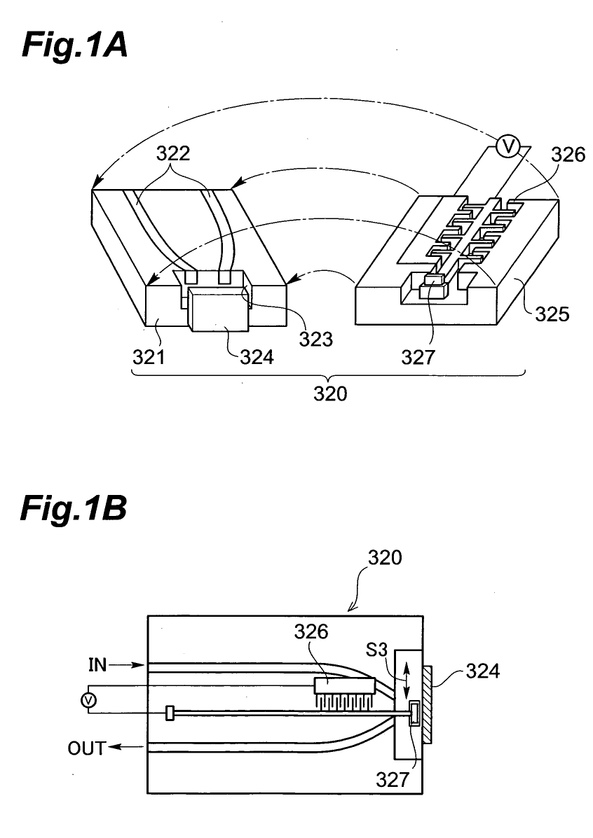

In the following, embodiments of a wavelength-selectable device and an optical communications system according to the present invention will be explained in detail with reference to FIGS. 1A to 5B, 6 and 7. In the explanation of the drawings, constituents identical to each other will be referred to with numerals identical to each other without repeating their overlapping descriptions.

FIGS. 1A and 1B are illustrations each showing a schematic configuration of a wavelength-selectable device according to the present invention. This wavelength-selectable device 320 comprises a waveguide substrate 321 having optical waveguides 322 in which multiplexed signals containing multiple wavelengths propagate, and a reinforcing plate 325 having an MEMS, as shown in FIG. 1A.

The waveguide substrate 321 is provided with a groove 323 traversing the optical waveguides 322, and a wavelength filter (included in the wavelength selector) such as a dielectric multilayer filter is fixed at a predetermined location on the waveguide substrate 321, where light having propagated through the optical waveguide 322 arrives. On the other hand, the MEMS including a comb-shaped electrode 326 is built in the reinforcing plate 325, and the head part thereof is moved in directions indicated by arrows S3 (see. FIG. 1B) by the comb-shaped electrode 326. A mirror 327 as a reflecting surface is attached to this head part, and the mirror 327 is housed in the groove 323 when the reinforcing plate 325 is attached to the waveguide substrate 321. In this manner, the MEMS functions as a driving mechanism for changing the position of the mirror 327 relative to the waveguides 322.

As described above, the wavelength-selectable device 320 is a wave guide type device integrally constructed of the waveguide substrate 321 with the optical waveguides 322 therein, the wavelength selecting filter 324, and the mirror 327, and has the structure enabling further downsizing.

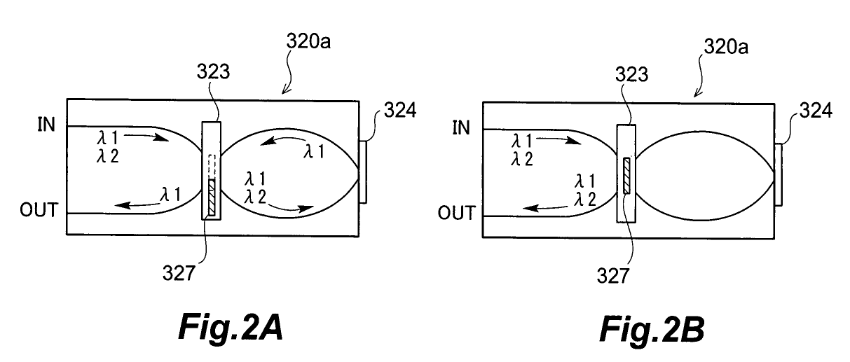

Next, a variety of embodiments of the wavelength-selectable device according to the present invention will be described with reference to FIGS. 2A to 5B. Each of FIGS. 2A, 3A, 4A and 5A shows a state in which the mirror is set at a position off the intersection of the optical waveguides 322, and each of FIGS. 2B, 3B, 4B and 5B shows a state in which the mirror is set at an intersection of the optical waveguides 322. These FIGS. 2A to 5B show the waveguide substrate 321 in a state without the reinforcing plate 325 having the MEMS.

First, FIGS. 2A and 2B are plan views each showing a configuration of a first embodiment of the wavelength-selectable device according to the present invention. In this wavelength-selectable device 320a of the first embodiment, the optical waveguides 322 include an input optical waveguide in which incident light (containing wavelengths λ1 and λ2) propagates, and an output optical waveguide in which output light propagates, and are arranged on the waveguide substrate 321 so that these input optical waveguide and output optical waveguide intersect at two locations.

The mirror 327 is arranged in a movable state in the groove 323 provided at a first intersection of these input optical waveguide and output optical waveguide. On the other hand, the wavelength selecting filter 324 is fixed to the waveguide substrate 321 and at a second intersection of these input optical waveguide and output optical waveguide.

In this wavelength-selectable device 320a of the first embodiment, in the state in which the mirror 327 is set at the position off the first intersection, the incident light of wavelengths λ1 and λ2 passes the first intersection in the input optical waveguide to reach the second intersection. Then the wavelength selecting filter 324 fixed at this second intersection reflects only the light of wavelength λ1 toward the input end of the output optical waveguide. This light of wavelength λ1 incident into the output optical waveguide travels as output light and passes the first intersection in the output optical waveguide to be outputted to the outside of the wavelength-selectable device 320a (see. FIG. 2A).

On the other hand, in the state in which the mirror 327 is set at the first intersection, the incident light of wavelengths λ1 and λ2 propagating in the input optical waveguide is reflected by the mirror 327 and enters the output optical waveguide as it is. Then this reflected light having propagated through the output optical waveguide is outputted to the outside of the wavelength-selectable device 320a (see FIG. 2B).

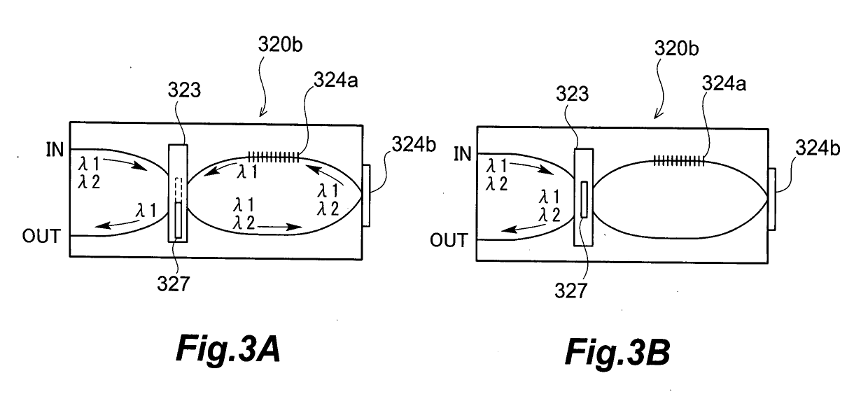

FIGS. 3A and 3B are plan views each showing a configuration of a second embodiment of the wavelength-selectable device according to the present invention. In this wavelength-selectable device 320b of the second embodiment, the optical waveguides 322 include an input optical waveguide in which incident light (containing wavelengths λ1 and λ2) propagates, and an output optical waveguide in which output light propagates, and are arranged on the waveguide substrate 321 so that these input optical waveguide and output optical waveguide intersect at two locations. The wavelength selector in the second embodiment is comprised of a mirror 324b fixed at the second intersection of the input optical waveguide and the output optical waveguide, and a diffraction grating 324a arranged on a linear portion of either of the input optical waveguide and the output optical waveguide and configured to transmit light of a specific wavelength only.

In this wavelength-selectable device 320b of the second embodiment, in the state in which the mirror 327 is set at the position off the first intersection, the incident light of wavelengths λ1 and λ2 passes the first intersection in the input optical waveguide to reach the second intersection. Then the light is reflected by the mirror 324b fixed at the second intersection and reaches the diffraction grating 324a provided on the linear portion of the output optical waveguide. This diffraction grating 324a transmits only the light of wavelength λ1 out of the incoming wavelengths λ1 and λ2. As a result, the light of wavelength λ1 having passed the diffraction grating 324a travels as output light and passes the first intersection in the output optical waveguide to be outputted to the outside of the wavelength-selectable device 320b (see. FIG. 3A).

On the other hand, in the state in which the mirror 327 is set at the first intersection, the incident light of wavelengths λ1 and λ2 propagating in the input optical waveguide is reflected by the mirror 327 and enters the output optical waveguide as it is. Then this reflected light having propagated through the output optical waveguide is outputted to the outside of the wavelength-selectable device 320b (see FIG. 3B).

In the second embodiment described above, the wavelength selector is comprised of the diffraction grating 324a and the mirror 324b, but the wavelength selector can also be implemented by a special waveguide structure and a diffraction grating. Specifically, it is also possible to use a waveguide substrate wherein the optical waveguides are an input optical waveguide and an output optical waveguide arranged to intersect at an intersection and wherein there is provided a loop waveguide the both ends of which are optically connected through the intersection to the input and output waveguides, respectively (i.e., a structure in which the input waveguide and output waveguide are directly coupled at the second intersection in FIGS. 3A and 3B). In this case, the wavelength selector for guiding only the light of the desired wavelength to the output waveguide without need for reflecting surface 324b can also be obtained by placing only the diffraction grating being the wavelength selector, on the linear portion of the loop waveguide.

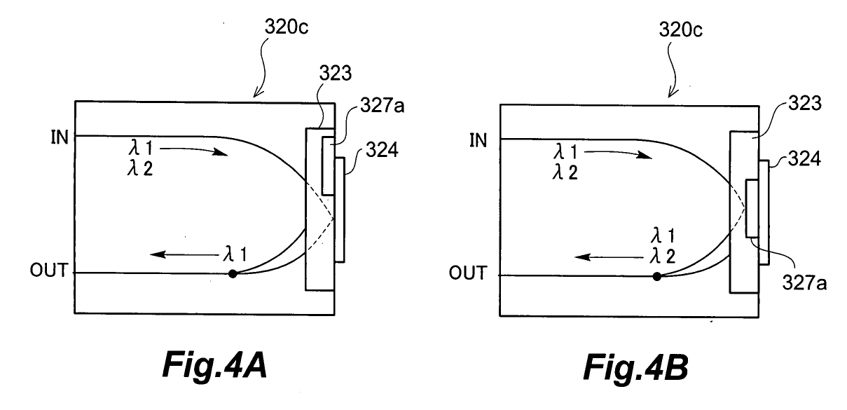

FIGS. 4A and 4B are plan views each showing a configuration of a third embodiment of the wavelength-selectable device according to the present invention. In the wavelength-selectable device 320c of the third embodiment, the optical waveguides 322 include an input optical waveguide in which incident light (containing wavelengths λ1 and λ2) propagates, and an output optical waveguide in which output light propagates, and are arranged on the waveguide substrate 321 so that these input optical waveguide and output optical waveguide intersect at one location. In this wavelength-selectable device 320c of the third embodiment, a thick mirror 327a is applied as the movable mirror.

The wavelength selecting filter 324 is fixed at the intersection of the input optical waveguide and the output optical waveguide to the waveguide substrate 321. On the other hand, the thick mirror 327a is arranged to be movable along a light entrance surface of the wavelength selecting filter 324, in the groove 323 provided at the intersection of these input optical waveguide and output optical waveguide.

In particular, in the case where the thick mirror 327a is used, a great deviation occurs between arrival positions of reflected light from the wavelength selecting filter 324 and reflected light from the thick mirror 327a. In this third embodiment, therefore, the output optical waveguide has a first input end into which the reflected light from the mirror 327a is incident when the mirror 327a is placed at the intersection of the input optical waveguide and the output optical waveguide, and a second input end into which the reflected light from the wavelength selecting filter is incident when the mirror 327a is placed at the position off the intersection of the input optical waveguide and the output optical waveguide.

In this wavelength-selectable device 320c of the third embodiment, in the state in which the thick mirror 327a is set at the position off the intersection, the incident light of wavelengths λ1 and λ2 travels through the input optical waveguide and arrives at the wavelength selecting filter 324 fixed at the intersection. Then only the light of wavelength k1 reflected by this wavelength selecting filter 324 is reflected toward the second input end of the output optical waveguide. The light of wavelength λ1 incident through the second input end into the output optical waveguide propagates as output light in the output optical waveguide to be outputted to the outside of the wavelength-selectable device 320c (see. FIG. 4A).

On the other hand, in the state in which the thick mirror 327a is set at the intersection, the incident light of wavelengths λ1 and λ2 propagating in the input optical waveguide is reflected by the mirror 327a and enters the output optical waveguide through the first input end as it is. Then the reflected light having propagated through the output optical waveguide is outputted to the outside of the wavelength-selectable device 320c (see FIG. 4B).

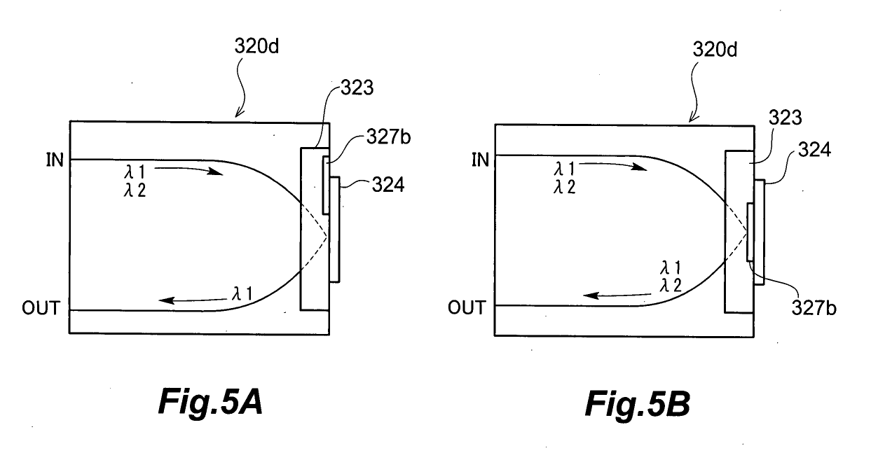

FIGS. 5A and 5B are plan views each showing a configuration of a fourth embodiment of the wavelength-selectable device according to the present invention. In this wavelength-selectable device 320d of the fourth embodiment, the optical waveguides 322 include an input optical waveguide in which incident light (containing wavelengths λ1 and λ2) propagates, and an output optical waveguide in which output light propagates, and are arranged on the waveguide substrate 321 so that these input optical waveguide and output optical waveguide intersect at one location. In this wavelength-selectable device 320d of the fourth embodiment, different from the aforementioned third embodiment, a thin mirror 327b is applied as the movable reflecting surface.

The wavelength selecting filter 324 is fixed at the intersection of the input optical waveguide and the output optical waveguide and to the waveguide substrate 321. On the other hand, the thin mirror 327b is arranged to be movable along the light entrance surface of the wavelength selecting filter 324, in the groove 323 provided at the intersection of these input optical waveguide and output optical waveguide. In the case of the mirror 327b adopted in this fourth embodiment, the arrival positions of the reflected light from the wavelength selecting filter 324 and the reflected light from the mirror 327b approximately coincide with each other, and thus the output optical waveguide has a single input end.

In this wavelength-selectable device 320d of the fourth embodiment, in the state in which the thin mirror 327b is set at the position off the intersection, the incident light of wavelengths λ1 and λ2 travels through the input optical waveguide and arrives at the wavelength selecting filter 324 fixed at the intersection. Then only the light of the wavelength λ1 reflected by this wavelength selecting filter 324 is reflected toward the input end of the output optical waveguide. The light of the wavelength λ1 entering the output optical waveguide propagates as output light in the output optical waveguide to be outputted to the outside of the wavelength-selectable device 320d (see. FIG. 5A).

On the other hand, in the state in which the thin mirror 327b is set at the intersection, the incident light of wavelengths λ1 and λ2 having propagated through the input optical waveguide is reflected by the mirror 327b and enters the output optical waveguide as it is. Then the reflected light having propagated through the output optical waveguide is outputted to the outside of the wavelength-selectable device 320d (see FIG. 5B).

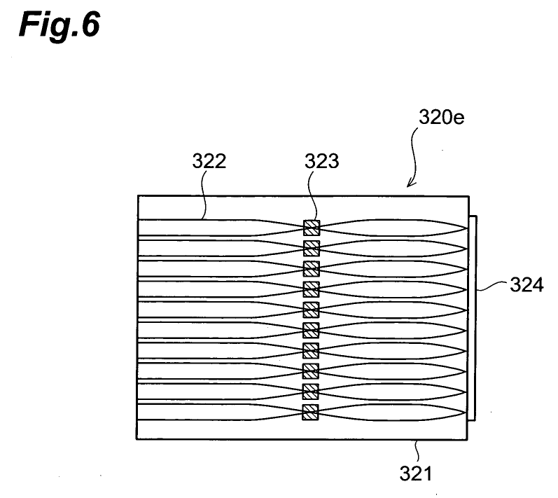

In all of the wavelength selecting filters 320a-320d of the respective embodiments described above, the optical waveguides consist of a set of the input optical waveguide and output optical waveguide. However, the wavelength-selectable devices according to the present invention are not limited to the embodiments of one input and one output, but may be implemented as embodiments of multiple inputs and multiple outputs. FIG. 6 is a plan view showing a configuration of a fifth embodiment implementing a multi-input and multi-output structure of the wavelength-selectable device according to the present invention. In this FIG. 6, the waveguide substrate 321 is also illustrated in a state without the reinforcing plate 325 having the MEMS.

As shown in FIG. 6, the wavelength-selectable device 320e of the fifth embodiment has a common waveguide substrate 321 in which a plurality of pairs of input optical waveguides and output optical waveguides are flatly built as optical waveguides 322. A groove 323 in which a movable mirror is set is provided at a first intersection in each pair. On the other hand, a common wavelength selecting filter 324 is fixed at second intersections of the respective pairs.

This wavelength-selectable device according to the present invention is a wavelength-selectable device of the waveguide type suitable for downsizing as described above. Systems to which the wavelength-selectable device is applicable are, for example, an optical communication system such as broadband communication to deliver the digital data signals used in the Internet or the like and the analog video signals used in the video delivery service or the like, an optical communication system for transmitting multiple types of analog signals as assigned to their respective different channels (wavelength bands), an optical communication system for transmitting a plurality of types of digital data signals as assigned to their respective different channels, an optical communication system for transmitting a video signal, a sound signal, and a data signal in a multiplexed state, an optical communication system for transmitting an identical data signal to different subscribers while assigning the data signal to different channels, and so on. A description will be given below, particularly, as to a specific example of application of the wavelength-selectable device 320 to an optical communication system providing the FTTH service recently drawing attention.

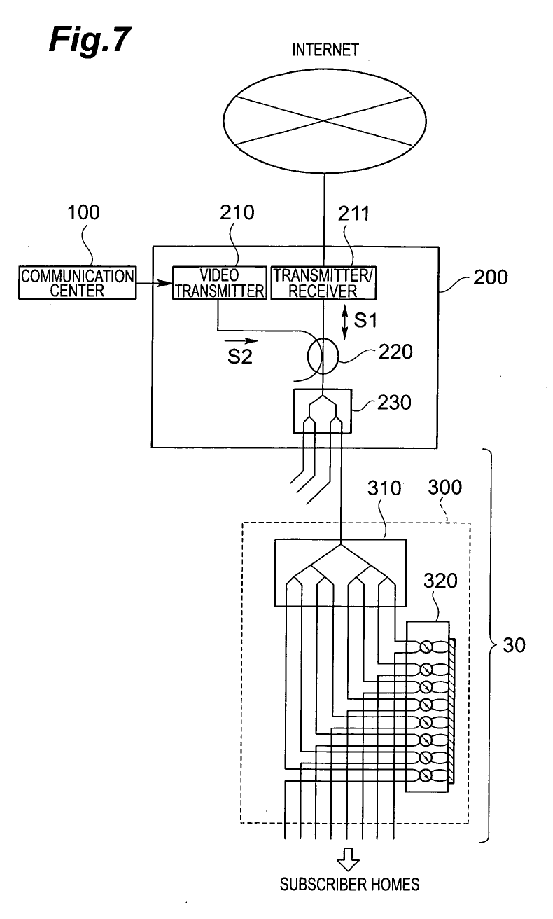

FIG. 7 is an illustration showing a schematic configuration of an optical communication system according to the present invention (including the wavelength-selectable device 320 according to the present invention), which provides the FTTH service. The optical communication system shown in this FIG. 7 is provided with a terminal 200 being a final repeater in an existing communication system, such as the Internet, and an optical fiber network 30 installed between the terminal 200 and subscriber homes. This optical fiber network 30 is provided with a closure 300 as a branch point located outside the subscriber homes.

The terminal 200 is equipped with a transmitter/receiver 211 for transmitting and receiving a digital data signal S1 to and from the existing communication network, such as the Internet, and a video transmitter 210 for guiding an analog video signal S2 from communication center 100 to the optical fiber network 30. The terminal 200 is also equipped with a coupler 220 as an optical multiplexer/demultiplexer for multiplexing or demultiplexing the digital data signal S1 from the transmitter/receiver 211 and the analog video signal S2 from the video transmitter 210, and a 1-to-4 splitter 230 for splitting the multiplexed signals from the coupler 220 into four signals to the optical fiber network 30.

In the closure 300 as a branch point of the optical fiber network 30, there are a 1-to-8 splitter 310 for further splitting the incoming multiplexed signals into eight signals, and the wavelength-selectable device 320e of the fifth embodiment as the wavelength-selectable device 320 prepared for each subscriber. This wavelength-selectable device 320 is configured to select at least either of the digital data signal and analog video signal in accordance with the contractual coverage of each subscriber from each multiplexed signals thus split, and to transmit the selected signal to the subscriber.

In the optical communication system shown in FIG. 7, as described above, the 1-to-4 splitter 230 is provided in the terminal 200 and the 1-to-8 splitter 320 is provided in the closure 300 in the optical fiber network 30; therefore, this configuration permits one terminal 200 to provide the FTTH service for thirty two subscribers.

In the optical communication system shown in FIG. 7, the wavelength-selectable device 320 is set in the closure 300 outside the subscriber homes, in order to facilitate communication carrier's management and modification of service contents of subscribers, but the location of the wavelength-selectable device 320 does not have to be limited, particularly, to the inside of the closure 300; for example, the wavelength-selectable device 320 may be installed at each subscriber home.

The wavelength-selectable devices according to the present invention are suitably applicable to an optical communication system enabling the broadband communication, particularly, the FTTH service to multiplex the digital data signals as in the Internet and the analog video signals used in the video delivery service or the like, an optical communication system for transmitting multiple types of analog signals as assigned to their respective different channels (wavelength bands), an optical communication system for transmitting multiple types of digital signals as assigned to their respective different channels, an optical communication system for transmitting a video signal, a sound signal, and a data signal in a multiplexed state, an optical communication system for transmitting an identical data signal to different subscribers while assigning the data signal to different channels, and so on.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A wavelength-selectable device for blocking or transmitting light in a predetermined wavelength band of an incident wavelength band, said wavelength-selectable device comprising:
a waveguide substrate in which an optical waveguide is formed;
a wavelength selector fixed at a predetermined location on said waveguide substrate, where light propagating in said optical waveguide arrives; and
a movable reflecting surface arranged on said waveguide substrate and in a movable state between a first position where the light propagating in said optical waveguide arrives and a second position off said optical waveguide.

2. A wavelength-selectable device according to claim 1, wherein said optical waveguide comprises an input optical waveguide and an output optical waveguide arranged to intersect at a plurality of locations, and
wherein said movable reflecting surface is arranged to be movable between a first intersection of said input optical waveguide and said output optical waveguide and a position off the first intersection, and said wavelength selector is fixed at a second intersection of said input optical waveguide and said output optical waveguide.

3. A wavelength-selectable device according to claim 2, wherein said wavelength selector is a dielectric multilayer filter.

4. A wavelength-selectable device according to claim 2, further comprising a common waveguide substrate in which a plurality of pairs of input optical waveguides and output optical waveguides are flatly built,
wherein a movable reflecting surface and a wavelength selector are arranged at predetermined positions for each of the plurality of pairs.

5. A wavelength-selectable device according to claim 1, wherein said optical waveguide comprises an input optical waveguide and an output optical waveguide arranged to intersect at least at one location, and
wherein said wavelength selector is fixed at the intersection of said input optical waveguide and said output optical waveguide, and said movable reflecting surface is arranged to be movable between the intersection of said input optical waveguide and said output optical waveguide and a position off the intersection.

6. A wavelength-selectable device according to claim 5, wherein said wavelength selector is a dielectric multilayer filter.

7. A wavelength-selectable device according to claim 5, further comprising a common waveguide substrate in which a plurality of pairs of input optical waveguides and output optical waveguides are flatly built,
wherein a movable reflecting surface and a wavelength selector are arranged at predetermined positions for each of the plurality of pairs.

8. A wavelength-selectable device according to claim 1, wherein said optical waveguide comprises an input optical waveguide and an output optical waveguide arranged to intersect at least at one location,
wherein said wavelength selector is fixed at the intersection of said input optical waveguide and said output optical waveguide, and said movable reflecting surface is arranged to be movable along said wavelength selector and between the intersection of said input optical waveguide and said output optical waveguide and a position off the intersection, and
wherein said output optical waveguide has a first input end into which reflected light from said movable reflecting surface is incident when said movable reflecting surface is placed at the intersection of said input optical waveguide and said output optical waveguide, and a second input end into which reflected light from said wavelength selector is incident when said movable reflecting surface is placed at the position off the intersection of said input optical waveguide and said output optical waveguide.

9. A wavelength-selectable device according to claim 8, wherein said wavelength selector is a dielectric multilayer filter.

10. A wavelength-selectable device according claim 8, further comprising a common waveguide substrate in which a plurality of pairs of input optical waveguides and output optical waveguides are flatly built,
wherein a movable reflecting surface and a wavelength selector are arranged at predetermined positions for each of the plurality of pairs.

11. A wavelength-selectable device according to claim 1, wherein said optical waveguide comprises an input optical waveguide and an output optical waveguide arranged to intersect at a plurality of locations,
wherein said movable reflecting surface is arranged to be movable between a first intersection of said input optical waveguide and said output optical waveguide and a position off the first intersection, and
wherein said wavelength selector is constituted by a reflecting surface fixed at a second intersection of said input optical waveguide and said output optical waveguide, and a diffraction grating for transmitting only light of a specific wavelength, which is arranged on a linear portion of one of said input optical waveguide and said output optical waveguide.

12. A wavelength-selectable device according to claim 11, further comprising a common waveguide substrate in which a plurality of pairs of input optical waveguides and output optical waveguides are flatly built,
wherein a movable reflecting surface and a wavelength selector are arranged at predetermined positions for each of the plurality of pairs.

13. A wavelength-selectable device according to claim 1, wherein said optical waveguide comprises an input optical waveguide and an output optical waveguide arranged to intersect at an intersection, and a loop waveguide both ends of which are optically connected to said input and output waveguides, respectively, through the intersection,
wherein said movable reflecting surface is arranged to be movable between the intersection of said input optical waveguide and said output optical waveguide and a position off the intersection, and
wherein said wavelength selector is a diffraction grating for transmitting only light of a specific wavelength, which is arranged on a linear portion of said loop optical waveguide.

14. A wavelength-selectable device according to claim 6, further comprising a common waveguide substrate in which a plurality of pairs of input optical waveguides and output optical waveguides are flatly built,
wherein a movable reflecting surface and a wavelength selector are arranged at predetermined positions for each of the plurality of pairs.

15. A wavelength-selectable device according to claim 1, further comprising a driving mechanism for changing a position of said reflecting surface relative to said optical waveguide.

16. An optical communication system for transmitting signal light through an optical fiber, said optical communication system comprising an wavelength-selectable device according to claim 1, which can separate an optical component of a predetermined wavelength from the signal light.
